(19) United States
(12) Patent Application Publication
(10) Pub. No.: US 2020/0338494 A1
(43) Pub. Date: Oct. 29, 2020

(54) JET ENGINE AND METHOD OF OPERATION

(71) Applicant: Norman A. Pullen, Tulsa, OK (US)

(72) Inventor: Norman A. Pullen, Tulsa, OK (US)

(21) Appl. No.: 16/393,370

(22) Filed: Apr. 24, 2019

(51) Int. Cl. B01D 53/047; F02K 99/00

(52) U.S. Cl. CPC B01D 53/047; F02K 99/00; B01D 2259/4575; B01D 2257/102; B01D 2256/12

(57) ABSTRACT

A jet engine assembly and a method of operation in which nitrogen is removed from air using a nitrogen adsorption system to create an O₂-rich product which adds to the air combusted in the jet engine, thus reducing fuel usage. In addition, a nitrogen product produced by the nitrogen adsorption system is preferably used for producing greater thrust.

### FIELD OF THE INVENTION

The present invention relates to a jet engine assembly and method of operation for providing increased fuel efficiency, improved performance, and greater thrust. The jet engine assembly and method of operation use an oxygen source which comprises a mixture of (a) air and (b) an oxygen-rich product which is produced from air.

### BACKGROUND OF THE INVENTION

A continuing need exists for jet engines and jet engine assemblies and methods which provide greater fuel efficiency and which also provide improved performance and increased thrust.

### SUMMARY OF THE INVENTION

The present invention provides a jet engine assembly and a method of operation in which nitrogen is removed from air to create an O₂-rich product. The O₂-rich product is injected into the combustion chamber, thus causing a larger explosion and more thrust and heat while also reducing the volume of fuel and gaining fuel economy. In addition a nitrogen product is also produced and preferably used for producing greater thrust. In one alternative, the basis for the increased thrust is that nitrogen is forced through a tube or duct that spirals the combustion chamber so that, as it gains heat, it cannot expand so its velocity increases. The flow of the hot nitrogen gas product into the turbine area causes higher gas velocity and thrust. The inventive jet engine assembly and method provide improvements in fuel efficiency of as much as 35% and thrust of as much as 35% or more. In addition, the oxygen and nitrogen products used in the inventive jet assembly and method are produced on demand from air and therefore do not require that any outside sources of oxygen or nitrogen be supplied and stored on-board.

In one aspect, there is provided a method of operating a jet engine to increase fuel efficiency, increase thrust, or a combination thereof, wherein the jet engine is powered by combusting a fuel with air and the method preferably comprises the steps of: (a) producing an oxygen-rich product from air using one or more pressure swing adsorption units which operate simultaneously with the jet engine and (b) delivering an amount of the oxygen-rich product to the jet engine which is used for combusting the fuel.

In another aspect, the method also preferably comprises the steps of: (c) producing a nitrogen product from the air using the one or more pressure swing adsorption units and (d) using the nitrogen product to provide increased thrust by delivering an amount of the nitrogen product (i) through one or more interior ducts extending through a combustion chamber within the inner housing, (ii) through one or more ducts which is/are positioned around the combustion chamber, (iii) into the inner housing between the combustion chamber and a low pressure exhaust turbine, or (iv) a combination thereof.

In another aspect, there is provided a jet engine assembly comprising: (1) one or more pressure swing adsorption units which produce an oxygen-rich product from air and (2) a jet engine. The jet engine preferably comprises: an outer housing having a forward air-intake end; an inner engine housing having at least a forward portion which is positioned within the outer housing, the inner engine housing further comprising (i) an air intake at a forward end of the inner engine housing and (ii) an internal combustion chamber within the inner engine housing; a by-pass air flow annulus formed between the inner engine housing and the outer housing; and an assembly within the inner engine housing comprising (i) a low pressure compressor and a high pressure compressor which are positioned forwardly of the internal combustion chamber and (ii) a high pressure exhaust turbine and a low pressure exhaust turbine which are positioned rearwardly of the internal combustion chamber. In addition, the jet engine assembly is preferably configured to deliver the oxygen-rich product produced by the one or more pressure swing adsorption units (i) into the air intake of the inner engine housing, (ii) into the inner engine housing forwardly of the internal combustion chamber, (iii) into the internal combustion chamber, or (iv) a combination thereof.

In another aspect, the jet engine assembly is also preferably configured to deliver a nitrogen product produced by the one or more pressure swing adsorption (i) through one or more interior ducts within the inner engine housing extending through the combustion chamber, (ii) through one or more ducts which is/are positioned around the combustion chamber, (iii) into the inner engine housing between the combustion chamber and the low pressure exhaust turbine, or (iv) a combination thereof.

Further aspects, features, and advantages of the present invention will be apparent to those in the art upon examining the accompanying drawings and upon reading the following Detailed Description of the Preferred Embodiments.

### BRIEF DESCRIPTION OF THE DRAWINGS

FIG. 1 is a cutaway view which schematically illustrates an embodiment 2 of the jet engine assembly provided by the present invention.

FIG. 2 schematically illustrates a pressure swing adsorption unit 6 used in the inventive jet engine assembly 2.

FIG. 3 is a cutaway end view of an adsorption media container 42a or 42b used in the pressure swing adsorption unit 6.

FIG. 4 schematically illustrates an alternative embodiment 100 of the jet engine assembly provided by the present invention.

FIG. 5 illustrates two of the inventive jet engine assemblies 100 installed on a commercial aircraft.

### DETAILED DESCRIPTION OF THE PREFERRED EMBODIMENTS

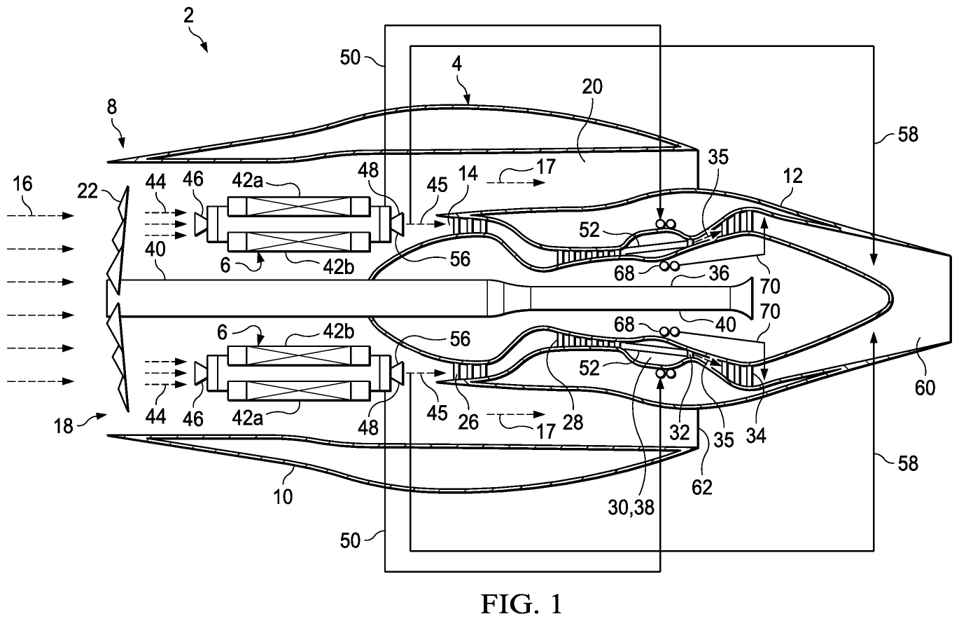

An embodiment 2 of the jet engine assembly provided by the present invention is illustrated in FIG. 1. The inventive jet engine assembly 2 preferably comprises a jet engine 4 and one or more, preferably four, pressure swing adsorption units 6 positioned in an extended forward air intake section 8 of the engine 4.

Although it will be understood that generally any type of jet engine can be used in the inventive jet engine assembly 2, the jet engine 4 shown in the embodiment of FIG. 1 is a modified high bypass engine which comprises: an outer nacelle housing 10 having an extended forward air intake section 8 as mentioned above; an inner engine housing 12 having a forward air intake 14 which preferably receives from about 10% to about 20% of the air flow 16 which enters the forward intake end 18 of the outer housing 10; an air flow annulus 20, formed between the inner housing 12 and the outer housing 10, through which the remainder 17 of the total air intake 16 travels; and an air intake fan 22 rotatably positioned at or within the forward end of the extended forward intake section 8 of the outer housing 10.

Positioned within the inner housing 12 of the jet engine 4 are: a low pressure air intake compressor 26 located within the forward air intake 14 end of the inner housing 12; a high pressure air intake compressor 28 located rearwardly of the low pressure compressor 26; a combustion chamber 30 located rearwardly of the high pressure air compressor 28 in a central combustion section 38 of the inner housing 12; a high pressure exhaust turbine 32 located rearwardly of the combustion chamber 30; and a low pressure exhaust turbine 34 located rearwardly of the high pressure turbine 32. Jet fuel is delivered to the combustion chamber 30 by a set of spray nozzles (not shown). The high pressure exhaust turbine 32 and the low pressure exhaust turbine 34 are driven (i.e., rotated) by the combustion exhaust stream 35 which flows from the combustion chamber 30.

The high pressure exhaust turbine 32 and the high pressure air intake compressor 28 are mounted on opposite end portions of a hollow, high pressure drive shaft 36 which extends through the central combustion section 38 of the inner housing 12. As the high pressure exhaust turbine 32 is driven by the combustion exhaust stream 35 flowing from the combustion chamber 30, the high pressure exhaust turbine 32 rotates the high pressure drive shaft 36, which in turn drives the rotation of the high pressure intake compressor 28.

Similarly, the low pressure exhaust turbine 34 and the low pressure air intake compressor 26 are mounted on a low pressure drive shaft 40 which extends through and rotates independently within the hollow, high pressure drive shaft 36. As the low pressure exhaust turbine 34 is driven by the exhaust stream 35 exiting the high pressure exhaust turbine 32, the low pressure exhaust turbine 34 rotates the low pressure drive shaft 40, which in turn drives the rotation of the low pressure intake compressor 26.

In addition, the air intake fan 22 is also mounted on a forwardly extending portion 40 of the low pressure drive shaft 40 which extends through and rotates independently within the hollow, high pressure drive shaft 36. Consequently, the rotation of the low pressure exhaust turbine 34 produced by the exhaust flow 35 from the combustion chamber 30 also drives the rotation of the air intake fan 22 within the extended forward air intake section 8 of the outer housing 10.

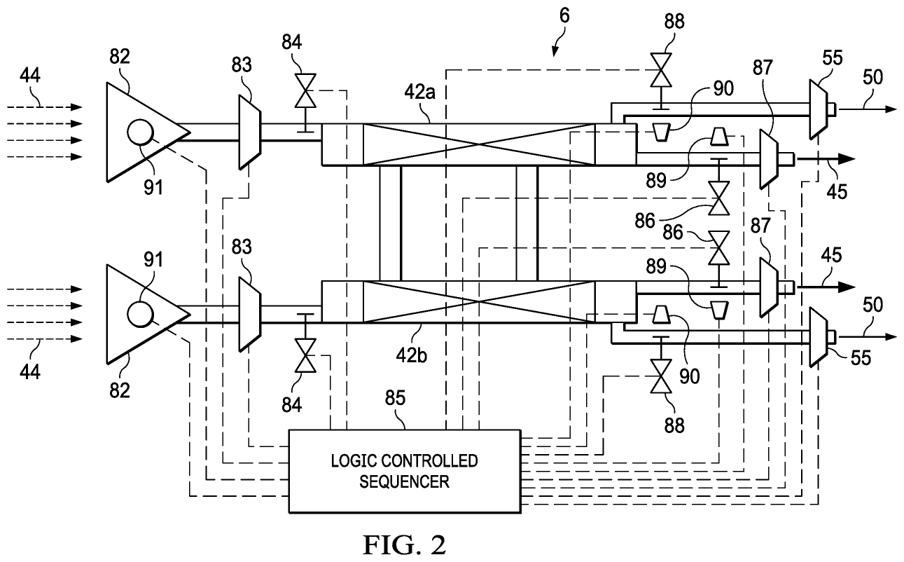

An embodiment of the one or more pressure swing adsorption units 6 used in the inventive jet engine assembly 2 is illustrated in FIG. 2. The one or more pressure swing adsorption units 6 used in the inventive assembly 2 are positioned in the extended forward air intake section 8 of the jet engine 4, rearwardly of the air intake fan 22. Each of the pressure swing adsorption units 6 comprises at least two (preferably four) cylindrical canisters or other containers 42a and 42b having an adsorption media therein for removing nitrogen from an incoming pressurized air stream 44. A ram air intake regime created by the forward motion of the jet engine 4 and by the rotation of the air intake fan 22 is used to pressurize the air stream 44 and deliver the pressurized air stream 44 to the forward inlet end 46 of each of the pressure swing adsorption units 6.

In each of the pressure swing adsorption units 6, the removal of nitrogen from the pressurized air stream 44 entering the adsorption unit 6 produces an oxygen-rich product stream 45 which is preferably discharged directly, on a continuous or substantially continuous basis, from the rearward discharge end 48 of the adsorption unit 6 into the forward air intake 14 end of the inner housing 12 of the jet engine 4. The one or more pressure swing adsorption units 6 are preferably sized and configured such that, in total, the additional volume of the oxygen-rich product stream(s) 45 added to the combustion mixture by the one or more adsorption units 6 will be the range of from about 3% to about 7% by volume, more preferably from about 4% to about 6%, of the volume of air alone. The adsorption media used in the containers 42a and 42b of each pressure swing adsorption unit 6 will preferably be an aluminosilicate material and will most preferably be zeolite, a porous stone material which acts as a molecular sieve. Under pressure, the zeolite or other aluminosilicate material removes nitrogen from an incoming pressurized air stream 44 to produce the oxygen-rich product steam 45. However, when the pressure is released, the nitrogen desorbs from the adsorption media and is preferably used in the inventive jet engine assembly 2 for producing increased thrust as will be discussed below.

As will be understood by those in the art, the atmospheric air flowing into the pressure swing adsorption unit(s) 6 will have an oxygen content of approximately 21% by volume and a nitrogen content of approximately 78% by volume. The adsorption media used in the pressure swing adsorption units 6 will preferably be effective for removing an amount of nitrogen from the incoming air stream such that the oxygen content of oxygen-rich product stream(s) 45 exiting the pressure swing adsorption unit(s) 6 adds at least an additional 3% by volume, more preferably at least an additional 5% by volume, of additional oxygen to the amount of air used during cruise operation. The nitrogen content of the oxygen rich product stream(s) 45 will preferably be less than 10% by volume.

The adsorption media used in the containers 42a and 42b of each pressure swing adsorption unit 6 will preferably be an aluminosilicate material and will most preferably be zeolite, a porous stone material which acts as a molecular sieve. Under pressure, the zeolite or other aluminosilicate material removes nitrogen from an incoming pressurized air stream 44 to produce the oxygen-rich product steam 45. However, when the pressure is released, the nitrogen desorbs from the adsorption media and is preferably used in the inventive jet engine assembly 2 for producing increased thrust as will be discussed below.

The at least two adsorption media containers 42a and 42b of each pressure swing adsorption unit 6 are continuously cycled, out of phase, between a high pressure (nitrogen adsorption) operating mode and a low pressure (nitrogen desorption) operating mode. Consequently, during a first stage of the pressure swing operation cycle, while the container 42a is operating in the high pressure nitrogen adsorption mode to remove nitrogen from the incoming air stream 44 and thereby produce the oxygen-rich product stream 45, the other container 42b will be operating in the low pressure regeneration mode to desorb the nitrogen from the adsorption media in the container 42b to produce a nitrogen product stream 50 which is used for providing increased thrust. Next, during a second stage of the pressure swing operation cycle, the incoming pressurized air stream 44 is diverted to the now regenerated adsorption media container 42b to continue the production of the oxygen-rich product stream 45 while the pressure in the adsorption media container 42a is released to regenerate the adsorption media therein and continue the production of the nitrogen product stream 50.

The nitrogen product stream 50 produced by each of the one or more pressure swing adsorption units 6 is conducted by a pump or compressor 55 into a duct or a spiral tube 68 around the combustion chamber 30 and is heated. The duct or spiral tube 68 preferably delivers the heated nitrogen via conduit 70 rearwardly downstream of the internal low pressure exhaust turbine 34. Heating the nitrogen within a fixed space increases its pressure and velocity, which then also supplements the rearward mass flow and velocity of the combined gases flowing from the discharge end of the jet engine 4 to provide increased thrust.

Alternatively, the nitrogen product stream 50 can be delivered by the pump or compressor 55 through interior ducts 52 which extend though the combustion chamber 30 such that the nitrogen product stream 50 combines with the exhaust 35 from combustion chamber 30 to provide increased thrust.

The thrust produced by the jet engine 4 results from a combination of (a) the discharge of the hot combustion gases from the tapered discharge nozzle 60 formed at the rearward end of the inner housing 12 of the engine 4, (b) the discharge of the air by-pass stream 17 and (c) the heated, expanded nitrogen product stream 50 delivered by spiral tube 68 via conduit 70 to the rearward end of low pressure exhaust turbine 34.

The benefit of adding the heated nitrogen product stream 50 to the engine exhaust stream 35 is to maintain and preferably increase the amount of thrust produced by the jet engine 4 in accordance with the following thrust equation:

Thrust=(Mₑ×Vₑ)−(Mₒ×Vₒ)

wherein the Thrust produced by the jet engine is equal to the difference between (a) the product of the mass flow rate (Mₑ) times the velocity (Vₑ) of the gases which are discharged from the rearward end of the engine minus (b) the product of the mass flow rate (Mₒ) times the velocity (Vₒ) at the forward air intake end of the engine. By way of example, in the inventive jet engine assembly and method, a 5% increase in volume from the O₂ stream results in a 35% increase in thrust and dictates a 5% increase in velocity due to the area being fixed.

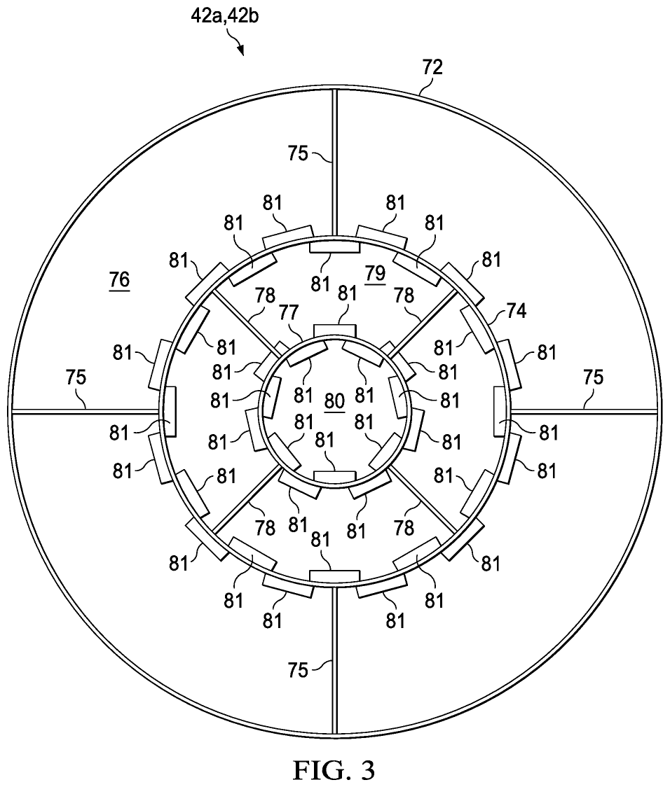

As illustrated in FIG. 3, each of the adsorption media containers 42a and 42b preferably comprises: an outer cylindrical housing 72; an intermediate cylinder 74 which is held in the cylindrical housing 72 by radial struts 75; an outer flow annulus 76 between the housing 72 and the intermediate cylinder 74: an inner cylinder 77 which is held in the intermediate cylinder 74 by radial struts 78; an inner flow annulus 79 which is formed between the intermediate cylinder 74 and the inner cylinder 77; a flow passage 80 extending through the inner cylinder 77: and a plurality of slats or strips 81, or coatings, of the aluminosilicate or other adsorption material extending longitudinally along the inner and outer surfaces of the inner and intermediate cylinders 77 and 74.

FIG. 2 illustrates that, at the inlet of the adsorption media containers 42a, 42b, an air funnel 82 is preferably provided to act as an air catchment device to accommodate the ram-air regime provided by the aircraft movement. Pumps or compressor 83 are also preferably provided in the inlets to push the air from the funnels 82 into the containers 42a, 42b. Control valves 84 following the pumps or compressors 83 are opened and closed by a logic sequencer 85, which may also turn the pumps or compressors 83 off and on for shifting between the nitrogen adsorption and desorption cycles. For the adsorption cycle, the sequencer 85 also opens the oxygen discharge control valve 86 and turns on the oxygen discharge pump or compressor 87 that pushes the oxygen-rich product stream 45 directly to intake of low pressure compressor 26 of the jet engine 4. Then, for the desorption cycle, the sequencer 85 closes the oxygen discharge control valve 86, turns off the oxygen pump or compressor 87, opens the nitrogen discharge control valve 88, and turns on the nitrogen pump or compressor 55. As noted above, the nitrogen discharge pump or compressor 55 pushes the nitrogen stream 50 into the tube or duct 68 provided around the combustion chamber 30 of the jet engine 4 for heating the nitrogen stream 50 prior to injecting the nitrogen stream 50 into the engine exhaust flow. Next, when returning to the adsorption cycle, the sequencer 85 closes the nitrogen control valve 88, turns off the nitrogen pump or compressor 55, opens the inlet air control valve 84, and starts the inlet air pump or compressor 83. The sequencer 85 also preferably allows the inlet air pump or compressor 83 and control valve 84 to push a minimum amount of air into the adsorption media container 42a or 42b for quick evacuation of the nitrogen from the containers. Check valves, flow diodes, or other suitable means (not shown) are also preferably provided as needed to prevent reverse flow through the containers 42a and 42b.

If the pressure swing adsorption unit 6 comprises two adsorption media containers 42a and two adsorption media containers 42b, the sequencer 85 will preferably cycle the containers 42a out-of-phase with the containers 42b so that when the containers 42a are in the adsorption cycle, the containers 42b will be operating in the desorption cycle and vice versa.

A sensor and bleed assembly 89 for the oxygen stream 45 and a sensor and bleed assembly 90 for the nitrogen stream 50 are also preferably provided to control the volume of oxygen and nitrogen by providing blow-by when required. Further, sensor and bleed assemblies 91 mounted on the inlet air funnel collectors 82 provide blow-by to relieve stress when required.

To further increase the thrust produced by the jet engine 4, a slip stream 58 of the O₂-rich product produced by the one or more pressure swing adsorption units 6 can also optionally be delivered to the discharge of the jet engine 4 to oxidize any uncombusted or partially combusted fuel in the exhaust stream to produce an afterburner effect.

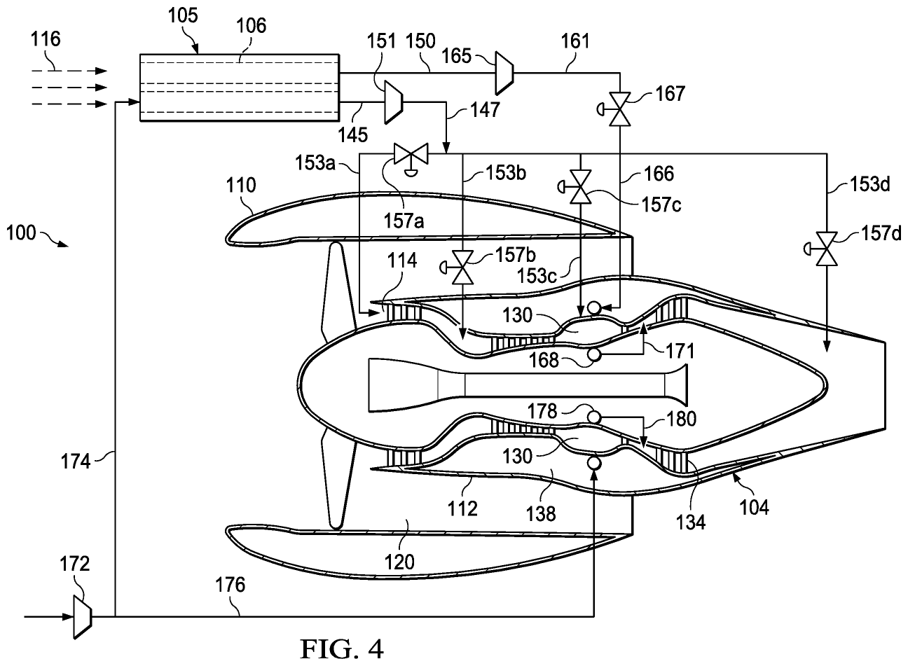

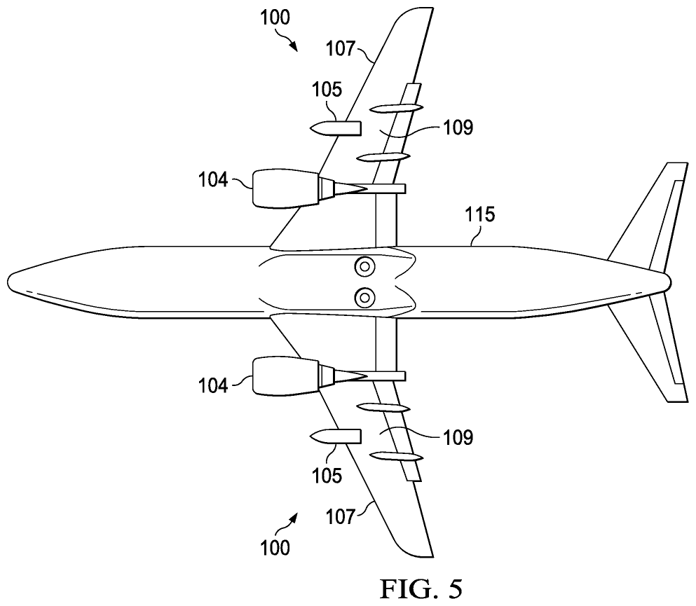

An alternative embodiment 100 of the inventive jet engine assembly is illustrated in FIGS. 4 and 5. The inventive engine assembly 100 is similar to the inventive engine assembly 2 except that the one or more pressure swing adsorption units 106 used in the inventive assembly 100 are not positioned in a forward extension of the outer housing 110 of the jet engine 104. Rather, the adsorption units 106 are housed within pods 105 which are secured, for example, on the undersides 109 of the wings 107 of a commercial aircraft 115. The pressure swing adsorption pods 105 are preferably spaced apart from the jet engines 104 and are also preferably slung on pylons so that the pods 105 are spaced downwardly from the undersides 109 of the wings 107.

As with the adsorption units 6, a ram air intake regime created by the forward motion of the pods 105 is used to provide a pressurized air stream 116 to the pressure swing adsorption units 106 contained therein. The pressure swing adsorption units 106 contained in each of the pods 105 adsorb nitrogen from the pressurized air stream 116 to produce a continuous or substantially continuous O₂-rich product stream 145 which is pumped for injection by a pump or compressor 151 via a conduit 147. The high pressure O₂-rich product 145 is then delivered (i) via a conduit 153a, as regulated by control valve 157a, to the forward air intake 114 of the inner housing 112 of the jet engine 104, (ii) via a conduit 153b, as regulated by control valve 157b, into the inner housing 112 at a point ahead of the combustion chamber 130, and/or (iii) via conduit 153c, as regulated by control valve 157c, into the engine combustion chamber 130.

In addition, an amount of the O₂-rich product 145 will alternately be delivered preferably during takeoff via a conduit 153d, as regulated by control valve 157d, to the discharge of the jet engine 104 to oxidize any uncombusted or partially combusted fuel in the exhaust stream to produce an afterburner effect.

The nitrogen product stream 150 produced by the pressure swing adsorption units 106 contained in each of the pods 105 is pumped for injection via a conduit 161 by a nitrogen pump or compressor 165. The pump or compressor 165 also assists in evacuating the adsorption unit containers operating in the desorption mode so that the low pressure nitrogen desorption process can occur.

In order to provide increased thrust, the pressurized nitrogen product 150 will preferably be delivered via conduit 166, as regulated by control valve 167, to a duct or tubing 168 which is coiled or otherwise positioned around the combustion chamber 130 and which delivers the heated nitrogen via conduit 171 rearwardly of the internal low pressure exhaust turbine 134.

In addition to or as a replacement for the use of a ram air flow regime to supply pressurized air to the pressure swing adsorption pods 105, the inventive jet assembly 100 can include a pump or compressor 172 which pumps outside air under pressure to the air intake of each of the pods 105 via a conduit 174. As another alternative, the pressure swing adsorption units 106 used in the inventive jet engine assembly 100 can be identical to the pressure swing adsorption units 6 used in the inventive jet engine assembly 2.

Alternatively or in addition, the pump or compressor 172 can pump outside air via a conduit 176 to a duct or tube 178 which coils or is otherwise positioned around the combustion chamber 130 for cooling the engine 104. The duct 178 then delivers the heated outside air via a conduit 180 to a point ahead of the internal low pressure exhaust turbine 134 to provide increased thrust.

Thus, the present invention is well adapted to carry out the objects and attain the ends and advantages mentioned above as well as those inherent therein. While presently preferred embodiments have been described for purposes of this disclosure, numerous changes and modifications will be apparent to those in the art. Such changes and modifications are encompassed within this invention as defined by the claims.

What is claimed is:

1. A jet engine assembly comprising:
one or more pressure swing adsorption units which produce an oxygen-rich product from air and
a jet engine which comprises
an outer housing having a forward air-intake end,
an inner engine housing having at least a forward portion which is positioned within the outer housing, the inner engine housing further comprising (i) an air intake at a forward end of the inner engine housing and (ii) an internal combustion chamber within the inner engine housing;
a by-pass air flow annulus formed between the inner engine housing and the outer housing, and
an assembly within the inner engine housing comprising (i) a low pressure compressor and a high pressure compressor which are positioned forwardly of the internal combustion chamber and (ii) a high pressure exhaust turbine and a low pressure exhaust turbine which are positioned rearwardly of the internal combustion chamber,
wherein the jet engine assembly is configured to deliver the oxygen-rich product produced by the one or more pressure swing adsorption units (i) into the air intake of the inner engine housing, (ii) into the inner engine housing forwardly of the internal combustion chamber, (iii) into the internal combustion chamber, or (iv) a combination thereof.

2. The jet engine assembly of claim 1 wherein the one or more pressure swing adsorption units is/are positioned forwardly of the air intake of the inner engine housing within a forwardly extending section of the outer housing.

3. The jet engine assembly of claim 2 wherein the one or more pressure swing adsorption units is/are positioned rearwardly of an air intake fan which is positioned within a forward end of the outer housing.

4. The jet engine assembly of claim 1 wherein the one or more pressure swing adsorption units is/are positioned outside of the outer housing of the jet engine and the jet engine assembly further comprises one or more conduits for delivering the oxygen-rich product produced by the pressure swing adsorption units (i) into the air intake of the inner engine housing, (ii) into the inner engine housing forwardly of the internal combustion chamber, (iii) into the internal combustion chamber, or (iv) a combination thereof.

5. The jet engine assembly of claim 1 wherein the jet engine assembly is configured to deliver a nitrogen product produced by the one or more pressure swing adsorption (i) through one or more interior ducts within the inner engine housing extending through the combustion chamber, (ii) through one or more ducts or tubes positioned around the combustion chamber, (iii) into the inner engine housing between the combustion chamber and the low pressure exhaust turbine, or (iv) a combination thereof.

6. The jet engine assembly of claim 1 wherein the jet engine assembly is also configured to deliver a portion of the oxygen-rich product produced by the one or more pressure swing adsorption units to an exhaust discharge of the jet engine to oxidize uncombusted and/or partially combusted fuel to produce an afterburner effect.

7. The jet engine assembly of claim 1 wherein the one or more pressure swing adsorption units is/are carried beneath a wing on a commercial aircraft.

8. The jet engine assembly of claim 1 further comprising one or more pumps or compressors which pump outside air (i) to an air intake of each of the one or more pressure swing adsorption units, (ii) to one or more ducts or tubes positioned around the combustion chamber, (iii) into the inner engine housing between the combustion chamber and the low pressure exhaust turbine, or (iv) a combination thereof.

9. A method of operating a jet engine to increase fuel efficiency, increase thrust, or a combination thereof, wherein the jet engine is powered by combusting a mixture of fuel and air and the method comprises the steps of:
a) producing an oxygen-rich product from air using one or more pressure swing adsorption units which operate simultaneously with the jet engine and
b) delivering an amount of the oxygen-rich product to the jet engine such that the amount of the oxygen-rich product is added to the mixture of the fuel and air for combusting the fuel.

10. The method of claim 9 wherein the oxygen-rich product produced in step (a) comprises less than 10% by volume of nitrogen.

11. The method of claim 10 wherein the air used to combust the fuel is a volumetric amount of air and the amount of the oxygen-rich product delivered to the jet engine in step (b) is a volumetric amount which is from about 4% to about 6% of the size of the volumetric amount of air.

12. The method of claim 9 wherein, in step (b), the amount of oxygen-rich product is delivered (i) into an air intake of an inner housing of the jet engine, (ii) into the inner housing forwardly of an internal combustion chamber of the jet engine, (iii) into the internal combustion chamber, or (iv) a combination thereof.

13. The method of claim 9 wherein the one or more pressure swing adsorption units is/are positioned in an outer housing of the jet engine.

14. The method of claim 9 wherein the one or more pressure swing adsorption units is/are carried beneath a wing of a commercial aircraft.

15. The method of claim 9 further comprising the step of delivering a portion of the oxygen-rich product produced in step (a) to an exhaust discharge of the jet engine which oxidizes uncombusted and/or partially combusted fuel to produce an afterburner effect.

16. The method of claim 9 further comprising:
producing a nitrogen product using the one or more pressure swing adsorption units and
using the nitrogen product to provide increased thrust by delivering an amount of the nitrogen product (i) through one or more interior ducts extending through a combustion chamber within an inner housing of the jet engine, (ii) through one or more ducts or tubes which is/are positioned around the combustion chamber, (iii) into the inner housing between the combustion chamber and a low pressure exhaust turbine, or (iv) a combination thereof.

17. The method of claim 9 further comprising delivering outside air (i) through one or more ducts or tubes positioned around a combustion chamber within an inner housing of the jet engine wherein the outside air is heated, (ii) into the inner housing between the combustion chamber and a low pressure exhaust turbine, or (iii) a combination thereof.
